(19) United States
(12) Patent Application Publication
(10) Pub. No.: US 2025/0375869 A1
(43) Pub. Date: Dec. 11, 2025

(54) Tool with Ergonomic Handle

(71) Applicant: Milwaukee Electric Tool Corporation, Brookfield, WI (US)

(72) Inventors: Jedidiah J. Babinec, Milwaukee, WI (US); Kyle A. Ritz, Burlington, WI (US); Michael James Brock, Sussex, WI (US)

(21) Appl. No.: 19/231,196

(22) Filed: Jun. 6, 2025

Related U.S. Application Data
(60) Provisional application No. 63/658,752, filed on Jun. 11, 2024.
(60) Provisional application No. 63/675,118, filed on Jul. 24, 2024.

(51) Int. Cl. B25G 1/10; B25B 15/02

(52) U.S. Cl. CPC B25G 1/105; B25B 15/02

(57) ABSTRACT

Various embodiments of a handle for tools, such as driving tools, such as screwdrivers, are provided. The embodiments shown and described herein include varying radii along the longitudinal axis of the handle, thereby facilitating the user interfacing with the handle, and thus also the tool, in different methods of use, such as quicker rotation, lower torque, and higher torque.

### CROSS-REFERENCE TO RELATED PATENT APPLICATIONS

The present application claims the benefit of and priority to U.S. Provisional Application No. 63/675,118 filed on Jul. 24, 2024, and U.S. Provisional Application No. 63/658,752 filed on Jun. 11, 2024, each which is incorporated herein by reference in its entirety.

### BACKGROUND OF THE INVENTION

The present disclosure is directed generally to the field of hand tools. The present disclosure relates specifically to a handle with an ergonomic handle design.

### SUMMARY OF THE INVENTION

One embodiment of the invention relates to a screwdriver including a handle extending along a longitudinal axis from a first end to a second end and an operative component rigidly coupled to the second end, the operative component being configured to interface with a fastener. The handle defines a first radius with respect to the longitudinal axis at a first distance from the first end to the second end, a second radius with respect to the longitudinal axis at a second distance from the first end to the second end that is greater than the first distance, the second radius being greater than the first radius, a third radius with respect to the longitudinal axis at a third distance from the first end to the second end that is greater than the second distance, the third radius being less than the first radius and an exterior surface of the handle at the third distance from the first end to the second end being parallel to the longitudinal axis, and a fourth radius with respect to the longitudinal axis at a fourth distance from the first end to the second end that is greater than the third distance, the fourth radius being less than the third radius.

Another embodiment of the invention relates to a screwdriver including a handle extending along a longitudinal axis from a first end to a second end, and an operative component rigidly coupled to the second end, the operative component being configured to interface with a fastener. The handle defines a first radius with respect to the longitudinal axis at a first distance from the first end to the second end, a second radius with respect to the longitudinal axis at a second distance from the first end to the second end that is greater than the first distance, the second radius being greater than the first radius, a third radius with respect to the longitudinal axis at a third distance from the first end to the second end that is greater than the second distance, the third radius being less than the first radius, and an exterior surface of the handle at the third distance from the first end to the second end being parallel to the longitudinal axis, and a fourth radius with respect to the longitudinal axis at a fourth distance from the first end to the second end that is greater than the third distance, the fourth radius being less than the third radius.

In various embodiments, a maximum radius of the handle is at the second distance from the first end to the second end. In various embodiments, a minimum radius of the handle is at the fourth distance from the first end to the second end. In various embodiments, the first distance is between 7% and 17% of the distance from the first end to the second end. In various embodiments, the second distance is between 27% and 37% of the distance from the first end to the second end. In various embodiments, the third distance is between 49% and 59% of the distance from the first end to the second end. In various embodiments, the fourth distance is between 71% and 81% of the distance from the first end to the second end.

Various embodiments of the invention relate to a hand tool with a handle configured to be gripped by a user. The handle facilitates comfortable gripping with a different cross-sectional shape at different positions along the longitudinal length of the handle. In specific embodiments, these different cross-sectional shapes are designed to facilitate different hand grip positions when gripping the tool using different grips.

Additional features and advantages will be set forth in the detailed description which follows, and, in part, will be readily apparent to those skilled in the art from the description or recognized by practicing the embodiments as described in the written description included, as well as the appended drawings. It is to be understood that both the foregoing general description and the following detailed description are exemplary.

The accompanying drawings are included to provide further understanding and are incorporated in and constitute a part of this specification. The drawings illustrate one or more embodiments and, together with the description, serve to explain principles and operation of the various embodiments. In addition, alternative exemplary embodiments relate to other features and combinations of features as may be generally recited in the claims.

### BRIEF DESCRIPTION OF THE DRAWINGS

This application will become more fully understood from the following detailed description, taken in conjunction with the accompanying figures, wherein like reference numerals refer to like elements in which:

FIG. 1 is a side view of a handle, according to an exemplary embodiment.

FIG. 2 is a side view of the handle of FIG. 1 being held, according to an exemplary embodiment.

FIG. 3 is a cross-section view of the handle of FIG. 1 taken along line 3-3 in FIG. 1, according to an exemplary embodiment.

FIG. 4 is a side view of the handle of FIG. 1 being held, according to an exemplary embodiment.

FIG. 5 is a cross-section view of the handle of FIG. 1 taken along line 5-5 in FIG. 1, according to an exemplary embodiment.

FIG. 6 is a side view of the handle of FIG. 1 being held, according to an exemplary embodiment.

FIG. 7 is a cross-section view of the handle of FIG. 1 taken along line 7-7 in FIG. 1, according to an exemplary embodiment.

FIG. 8 is a side view of the handle of FIG. 1 being held, according to an exemplary embodiment.

FIG. 9 is a cross-section view of the handle of FIG. 1 taken along line 9-9 in FIG. 1, according to an exemplary embodiment.

FIG. 10 is a side view of the handle of FIG. 1, according to an exemplary embodiment.

FIG. 11 is a cross-section view of the handle of FIG. 1 taken along line 11-11 in FIG. 10, according to an exemplary embodiment.

FIG. 12 is a cross-section view of the handle of FIG. 1 taken along line 12-12 in FIG. 10, according to an exemplary embodiment.

FIG. 13 is a cross-section view of the handle of FIG. 1 taken along line 13-13 in FIG. 10, according to an exemplary embodiment.

FIG. 14 is a cross-section view of the handle of FIG. 1 taken along line 14-14 in FIG. 10, according to an exemplary embodiment.

FIG. 15 is a cross-section view of the handle of FIG. 1 taken along line 15-15 in FIG. 10, according to an exemplary embodiment.

FIG. 16 is a perspective view of the handle of FIG. 1, according to an exemplary embodiment.

FIG. 17 is a perspective view of the handle of FIG. 1, according to an exemplary embodiment.

FIG. 18 is a front view of the handle of FIG. 1, according to an exemplary embodiment.

FIG. 19 is a side view of a handle, according to another exemplary embodiment.

FIG. 20 is a cross-section view of the handle of FIG. 19 taken along line 20-20 in FIG. 19, according to an exemplary embodiment.

FIG. 21 is a cross-section view of the handle of FIG. 19 taken along line 21-21 in FIG. 19, according to an exemplary embodiment.

FIG. 22 is a cross-section view of the handle of FIG. 19 taken along line 22-22 in FIG. 19, according to an exemplary embodiment.

FIG. 23 is a cross-section view of the handle of FIG. 19 taken along line 23-23 in FIG. 19, according to an exemplary embodiment.

FIG. 24 is a cross-section view of the handle of FIG. 19 taken along line 24-24 in FIG. 19, according to an exemplary embodiment.

FIG. 25 is a perspective view of the handle of FIG. 19, according to an exemplary embodiment.

FIG. 26 is a perspective view of the handle of FIG. 19, according to an exemplary embodiment.

FIG. 27 is a front view of the handle of FIG. 19, according to an exemplary embodiment.

FIG. 28 is a side view of a handle, according to another exemplary embodiment.

FIG. 29 is a side view of the handle of FIG. 28, according to an exemplary embodiment.

FIG. 30 is a rear view of the handle of FIG. 28, according to an exemplary embodiment.

FIG. 31 is a front view of the handle of FIG. 28, according to an exemplary embodiment.

FIG. 32 is a side view of the handle of FIG. 28, according to an exemplary embodiment.

FIG. 33 is a side view of a handle, according to another exemplary embodiment.

FIG. 34 is a side view of the handle of FIG. 33, according to an exemplary embodiment.

FIG. 35 is a front view of the handle of FIG. 33, according to an exemplary embodiment.

FIG. 36 is a rear view of the handle of FIG. 33, according to an exemplary embodiment.

FIG. 37 is a side view of the handle of FIG. 33, according to an exemplary embodiment.

FIG. 38 is a side view of a handle, according to another exemplary embodiment.

FIG. 39 is a side view of the handle of FIG. 39, according to an exemplary embodiment.

FIG. 40 is a rear view of the handle of FIG. 40, according to an exemplary embodiment.

FIG. 41 is a front view of the handle of FIG. 41, according to an exemplary embodiment.

FIG. 42 is a side view of the handle of FIG. 42, according to an exemplary embodiment.

FIG. 43 is a side view of a handle, according to another exemplary embodiment.

FIG. 44 is a side view of the handle of FIG. 43, according to an exemplary embodiment.

FIG. 45 is a rear view of the handle of FIG. 43, according to an exemplary embodiment.

FIG. 46 is a front view of the handle of FIG. 43, according to an exemplary embodiment.

FIG. 47 is a side view of the handle of FIG. 43, according to an exemplary embodiment.

FIG. 48 is a side view of a handle, according to another exemplary embodiment.

FIG. 49 is a side view of the handle of FIG. 48, according to an exemplary embodiment.

FIG. 50 is a rear view of the handle of FIG. 48, according to an exemplary embodiment.

FIG. 51 is a front view of the handle of FIG. 48, according to an exemplary embodiment.

FIG. 52 is a side view of the handle of FIG. 48, according to an exemplary embodiment.

FIG. 53 is a side view of a handle, according to another exemplary embodiment.

FIG. 54 is a side view of the handle of FIG. 53, according to an exemplary

embodiment.

FIG. 55 is a rear view of the handle of FIG. 53, according to an exemplary embodiment.

FIG. 56 is a front view of the handle of FIG. 53, according to an exemplary embodiment.

FIG. 57 is a side view of the handle of FIG. 53, according to an exemplary embodiment.

FIG. 58 is a side view of a handle, according to another exemplary embodiment.

FIG. 59 is a side view of the handle of FIG. 58, according to an exemplary embodiment.

FIG. 60 is a rear view of the handle of FIG. 58, according to an exemplary embodiment.

FIG. 61 is a front view of the handle of FIG. 58, according to an exemplary embodiment.

FIG. 62 is a side view of the handle of FIG. 58, according to an exemplary embodiment.

FIG. 63 is a side view of a handle, according to another exemplary embodiment.

FIG. 64 is a side view of the handle of FIG. 63, according to an exemplary embodiment.

FIG. 65 is a rear view of the handle of FIG. 63, according to an exemplary embodiment.

FIG. 66 is a front view of the handle of FIG. 63, according to an exemplary embodiment.

FIG. 67 is a side view of the handle of FIG. 63, according to an exemplary embodiment.

FIG. 68 is a side view of a handle, according to another exemplary embodiment.

FIG. 69 is a side view of the handle of FIG. 68, according to an exemplary embodiment.

FIG. 70 is a rear view of the handle of FIG. 68, according to an exemplary embodiment.

FIG. 71 is a front view of the handle of FIG. 68, according to an exemplary embodiment.

FIG. 72 is a side view of the handle of FIG. 68, according to an exemplary embodiment.

### DETAILED DESCRIPTION

Referring generally to the figures, various embodiments of a hand tool with a handle configured to be gripped by a user are shown. The handle facilitates comfortable gripping with a different cross-sectional shape and radii at different positions along the longitudinal length of the handle. In specific embodiments, these different cross-sectional shapes and radii are designed to facilitate different hand grip positions when gripping the tool using different grips.

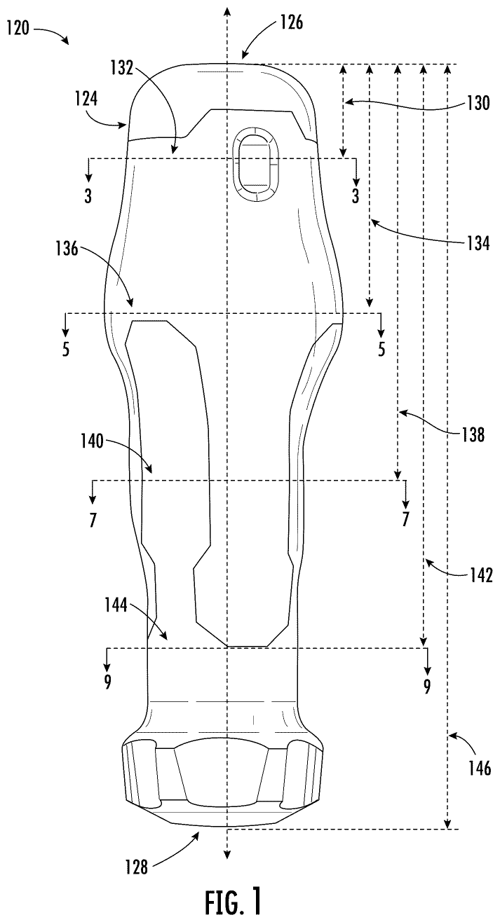

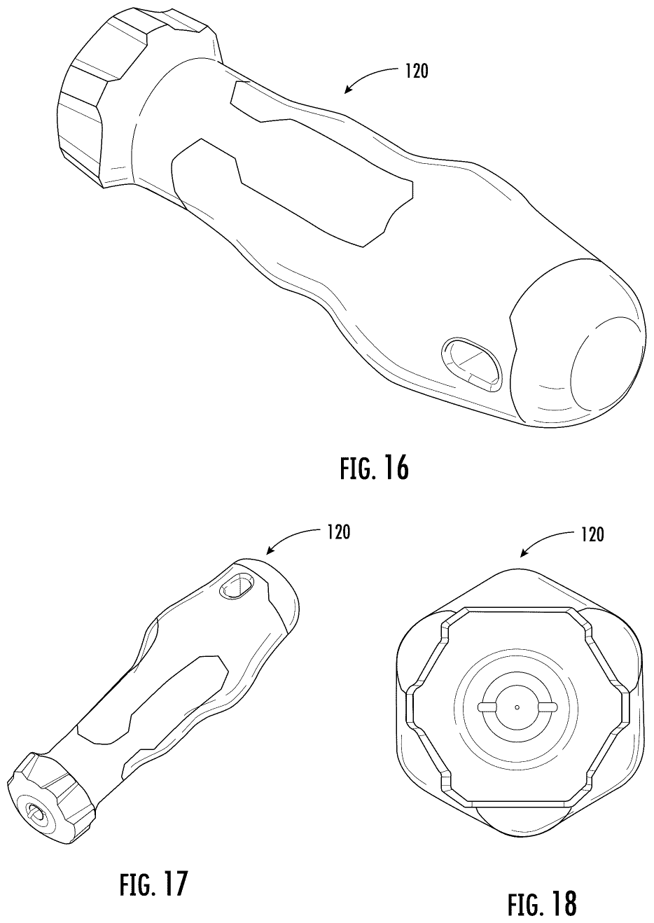

Referring to FIGS. 1-18, various aspects of handle 120 are shown. Screwdriver 110 includes handle 120 and operative component 112 rigidly coupled to the second end 128 of handle 120, such as handle 120 and operative component 112 being insert molded together, the operative component 112 being configured to interface with a fastener, such as a screw. Handle 120 extends along longitudinal axis 122 from first end 126 to second end 128.

Handle 120 defines first radius 132 with respect to the longitudinal axis 122 at a first distance 130 from the first end 126 to the second end 128. Handle 120 defines second radius 136 with respect to the longitudinal axis 122 at a second distance 134 from the first end 126 to the second end 128 that is greater than the first distance 130, and the second radius 136 is greater than the first radius 132.

Handle 120 defines third radius 140 with respect to the longitudinal axis 122 at a third distance 138 from the first end 126 to the second end 128 that is greater than the second distance 134, and the third radius 140 is less than the first radius 132, and an exterior surface 124 of the handle 120 at the third distance 138 from the first end 126 to the second end 128 is parallel to the longitudinal axis 122. Handle 120 defines fourth radius 144 with respect to the longitudinal axis 122 at a fourth distance 142 from the first end 126 to the second end 128 that is greater than the third distance 138, and the fourth radius 144 is less than the third radius 140.

In various embodiments, a maximum radius of the handle 120 is at the second distance 134 from the first end 126 to the second end 128. In various embodiments, a minimum radius of the handle 120 is at the fourth distance 142 from the first end 126 to the second end 128.

In various embodiments, the first distance 130 is between 7% and 17% of the distance from the first end 126 to the second end 128, and more particularly between 9% and 15%, and more particularly between 11% and 13%, and even more particularly is 12%.

In various embodiments, the second distance 134 is between 27% and 37% of the distance from the first end 126 to the second end 128, and more particularly between 29% and 35%, and more particularly between 31% and 33%, and even more particularly is 32%.

In various embodiments, the third distance 138 is between 49% and 59% of the distance from the first end 126 to the second end 128, and more particularly between 51% and 57%, and more particularly between 53% and 55%, and even more particularly is 54%.

In various embodiments, the fourth distance 142 is between 71% and 81% of the distance from the first end 126 to the second end 128, and more particularly between 73% and 79%, and more particularly between 75% and 77%, and even more particularly is 76%.

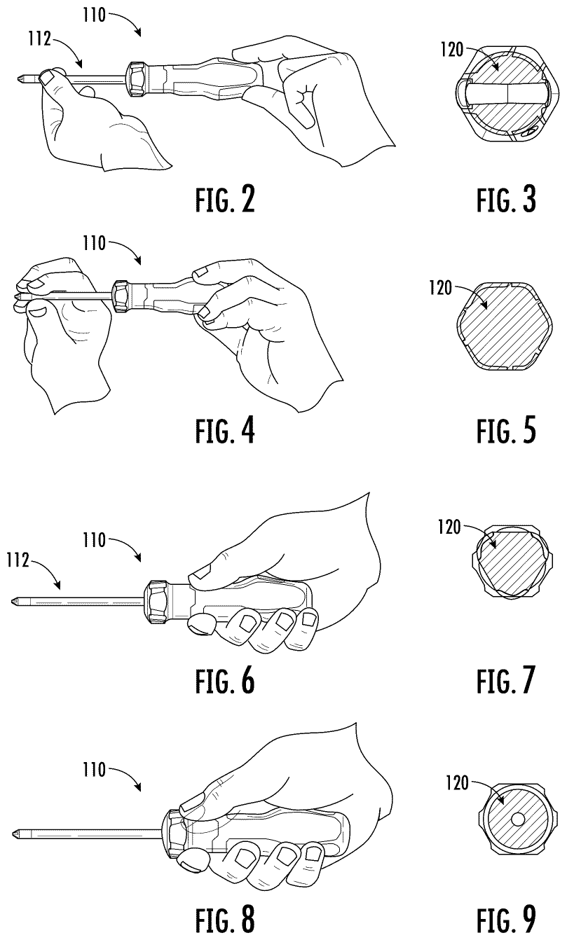

Referring to FIGS. 2-9, various positions for grasping handle 120 of screwdriver 110 are shown in FIGS. 2, 4, 6, and 8. The cross-sections shown in FIGS. 3, 5, 7, and 9 generally correspond to the portion of handle 120 being grasped by the index finger and thumb of the user in FIGS. 2, 4, 6, and 8. Applicant has observed that the radii of handle 120 and the shapes of handle 120 at cross-sections 3-3, 5-5, 7-7, and 9-9 facilitate users manipulating handle 120 in various use cases.

In FIG. 2, the index finger and thumb of the user are interacting with the handle 120 at the cross-section 3-3 identified in FIG. 1 and shown in FIG. 3. Applicant has observed that some users interface with handle 120 in this way when quickly rotating handle 120.

In FIG. 4, the index finger and thumb of the user are interacting with the handle 120 at the cross-section 5-5 identified in FIG. 1 and shown in FIG. 5. Applicant has observed that some users interface with handle 120 in this way when doing low torque (relative to other uses) rotations of handle 120.

In FIG. 6, the index finger and thumb of the user are interacting with the handle 120 at the cross-section 7-7 identified in FIG. 1 and shown in FIG. 7. Applicant has observed that some users interface with handle 120 in this way when doing higher torque (relative to other uses) rotations of handle 120.

In FIG. 8, the index finger and thumb of the user are interacting with the handle 120 at the cross-section 9-9 identified in FIG. 1 and shown in FIG. 9. Applicant has observed that some users interface with handle 120 in this way when doing quick controlled rotations of handle 120.

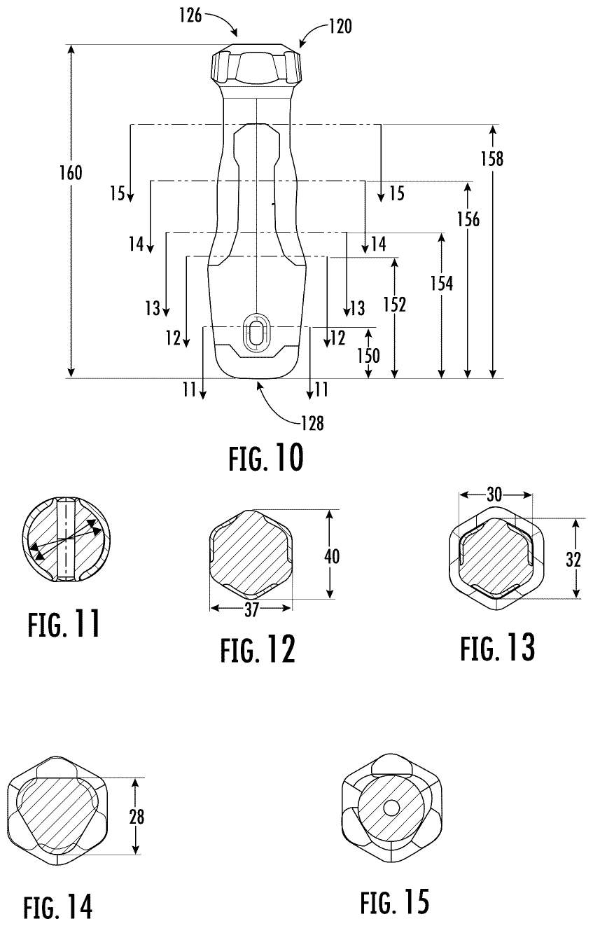

Referring to FIGS. 10-18, various aspects of handle 120 are shown. In various embodiments, distance 150 from first end 126 to cross-section 11-11 is 18.9 mm. In various embodiments, distance 152 from first end 126 to cross-section 12-12 is 45.3 mm. In various embodiments, distance 154 from first end 126 to cross-section 13-13 is 54.3 mm. In various embodiments, distance 156 from first end 126 to cross-section 14-14 is 73.3 mm. In various embodiments, distance 158 from first end 126 to cross-section 15-15 is 94.8 mm. In various embodiments, distance 158 from first end 126 to second end 128 is 124.3 mm. Applicant has observed that the radii of handle 120 and the shapes of handle 120 at cross-sections 11-11, 12-12, 13-13, 14-14, and 15-15 facilitate users manipulating handle 120 in various use cases.

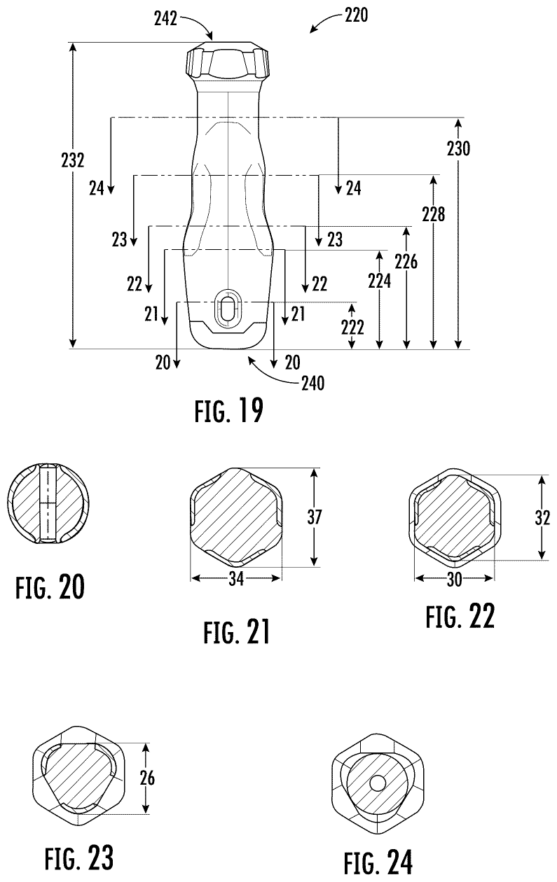

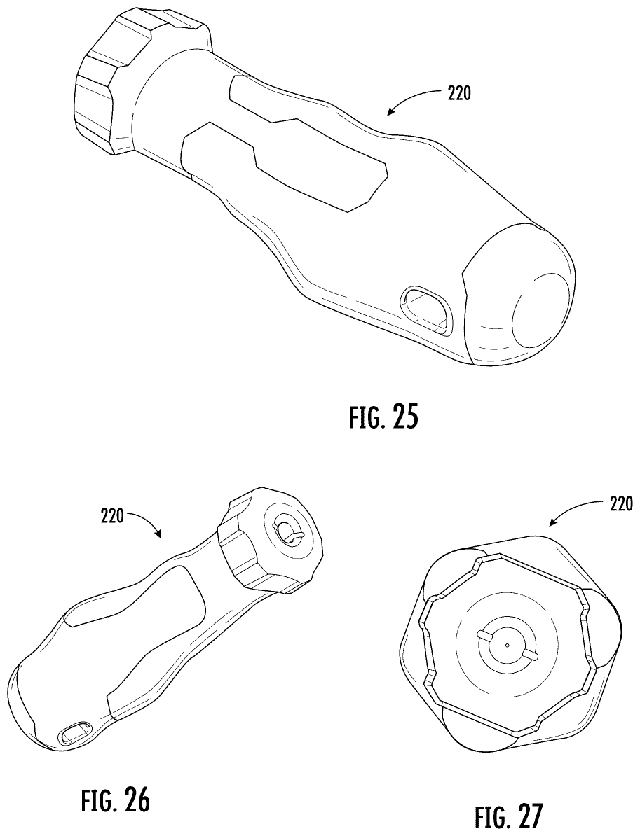

Referring to FIGS. 19-27, various aspects of handle 220 are shown. Handle 220 is functionally and structurally the same as handle 120 except for the differences described herein.

Referring to FIGS. 19-24, various aspects of handle 220 are shown. In various embodiments, distance 222 from first end 240 to cross-section 20-20 is 17.5 mm. In various embodiments, distance 224 from first end 240 to cross-section 21-21 is 37.1 mm. In various embodiments, distance 226 from first end 240 to cross-section 22-22 is 46.1 mm. In various embodiments, distance 228 from first end 240 to cross-section 23-23 is 65.1 mm. In various embodiments, distance 230 from first end 240 to cross-section 24-24 is 86.6 mm. In various embodiments, distance 232 from first end 240 to second end 242 is 115.1 mm. Applicant has observed that the radii of handle 220 and the shapes of handle 220 at cross-sections 20-20, 21-21, 22-22, 23-23, and 24-24 facilitate users manipulating handle 120 in various use cases.

Referring to FIGS. 19-24, in various embodiments distance 222 from first end 240 to cross-section 20-20 is 15 mm, distance 224 from first end 240 to cross-section 21-21 is 33 mm, distance 226 from first end 240 to cross-section 22-22 is 41 mm, distance 228 from first end 240 to cross-section 23-23 is 58 mm, distance 230 from first end 240 to cross-section 24-24 is 80 mm. In various embodiments, radius 34 is 29 mm, radius 37 is 32 mm, radius 30 is 25 mm, radius 32 is 27 mm, and radius 26 is 21 mm. Applicant has observed that the radii of handle 220 and the shapes of handle 220 at cross-sections 20-20, 21-21, 22-22, 23-23, and 24-24 facilitate users manipulating handle 120 in various use cases.

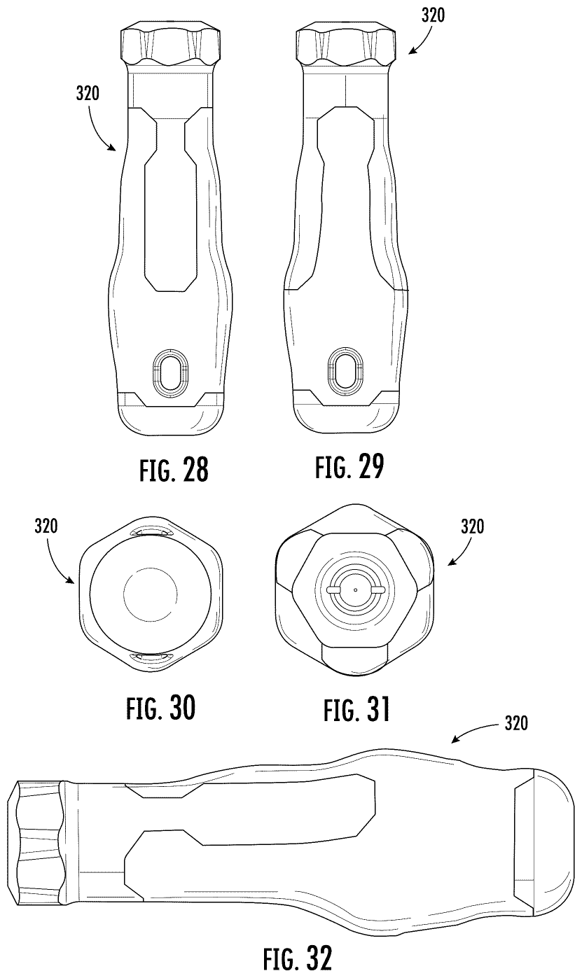

Referring to FIGS. 28-32, various aspects of handle 320 are shown. Handle 320 is functionally and structurally the same as handle 120 or handle 220 except for the differences described herein. In particular, in various embodiments the length of handle 320 is 119.8 mm.

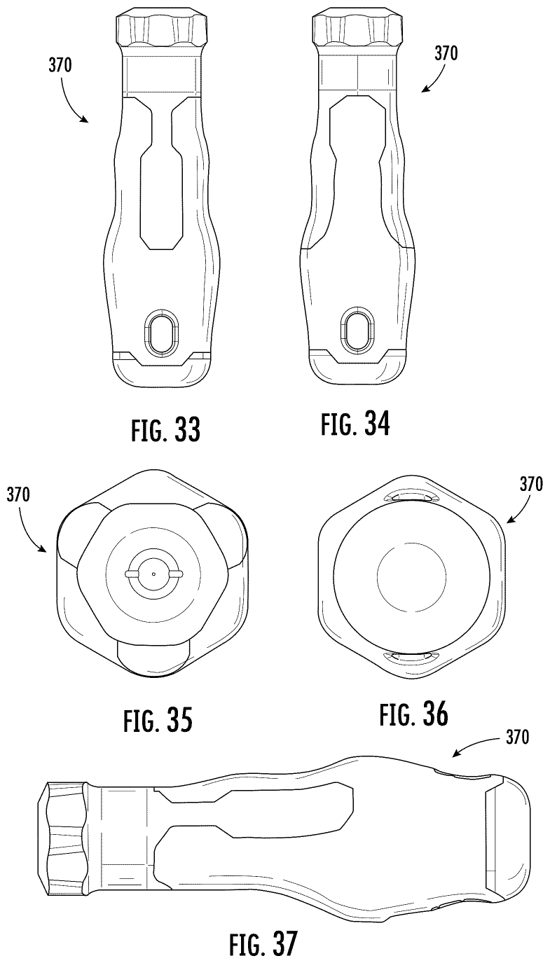

Referring to FIGS. 33-37, various aspects of handle 370 are shown. Handle 370 is functionally and structurally the same as handle 120, handle 220 or handle 320 except for the differences described herein. In particular, in various embodiments the length of handle 370 is 111.1 mm.

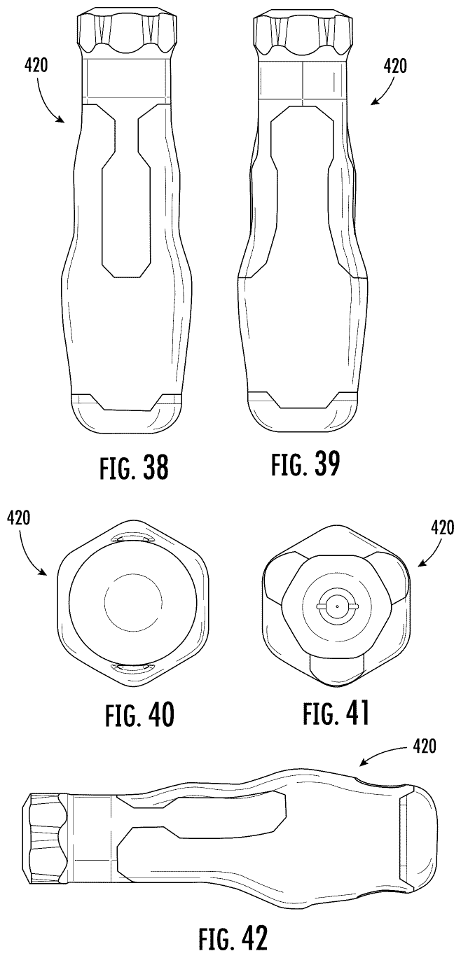

Referring to FIGS. 38-42, various aspects of handle 420 are shown. Handle 420 is functionally and structurally the same as handle 120, handle 220, handle 320 or handle 370 except for the differences described herein. In particular, in various embodiments the length of handle 420 is 93.34 mm.

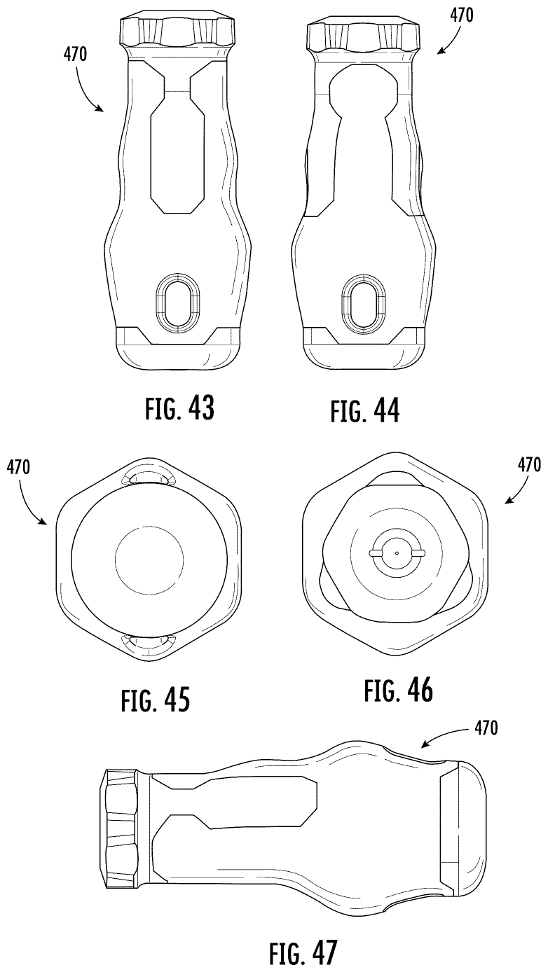

Referring to FIGS. 43-47, various aspects of handle 470 are shown. Handle 470 is functionally and structurally the same as handle 120, handle 220, handle 320, handle 370 or handle 420 except for the differences described herein. In particular, in various embodiments the length of handle 470 is 83.33 mm.

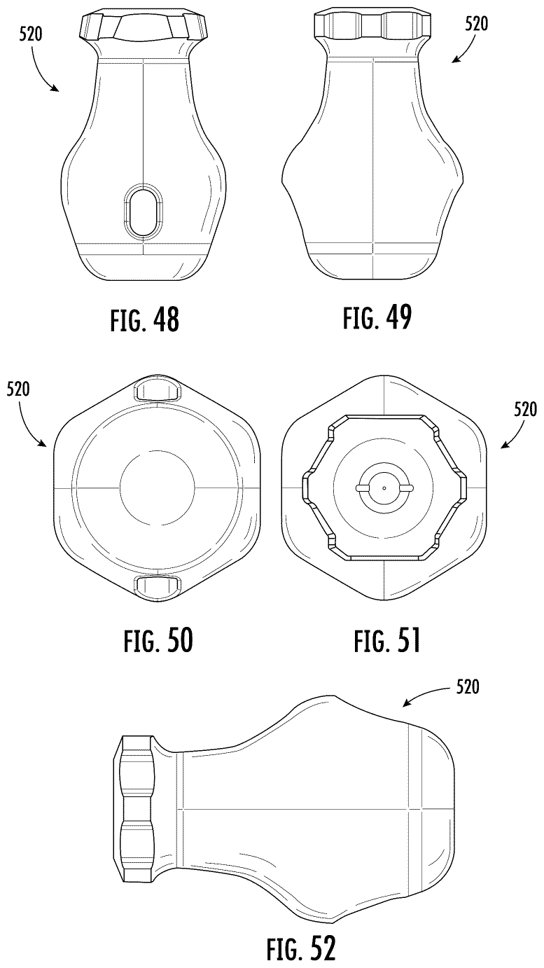

Referring to FIGS. 48-52, various aspects of handle 520 are shown. Handle 520 is functionally and structurally the same as handle 120, handle 220, handle 320, handle 370, handle 420 or handle 470 except for the differences described herein. In particular, in various embodiments the length of handle 520 is 59.57 mm.

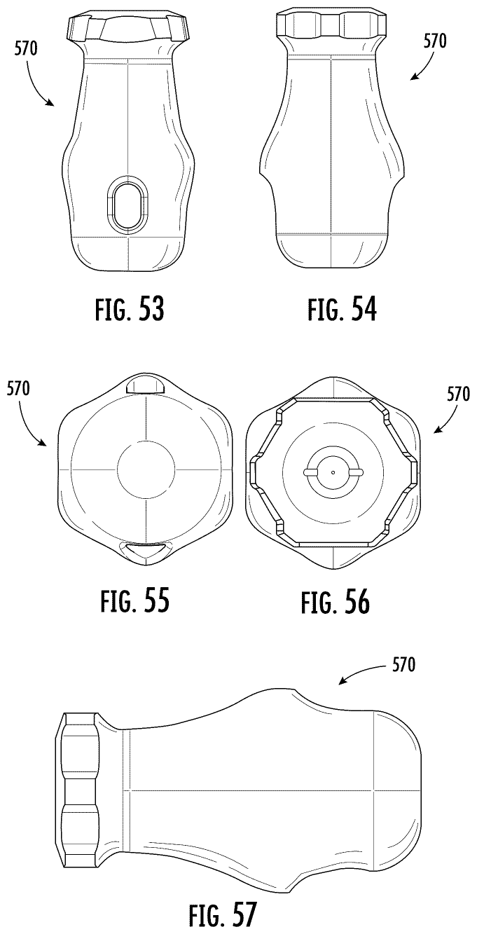

Referring to FIGS. 53-57, various aspects of handle 570 are shown. Handle 570 is functionally and structurally the same as handle 120, handle 220, handle 320, handle 370, handle 420, handle 470, or handle 520 except for the differences described herein. In particular, in various embodiments the length of handle 570 is 59.57.

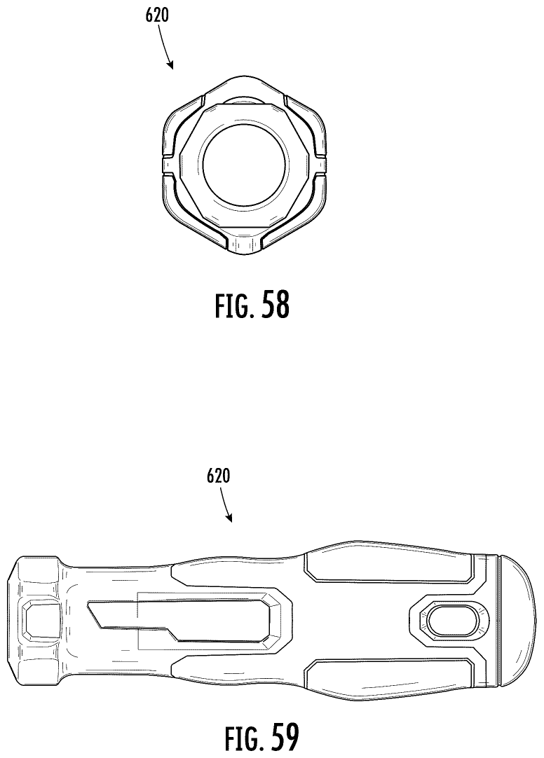

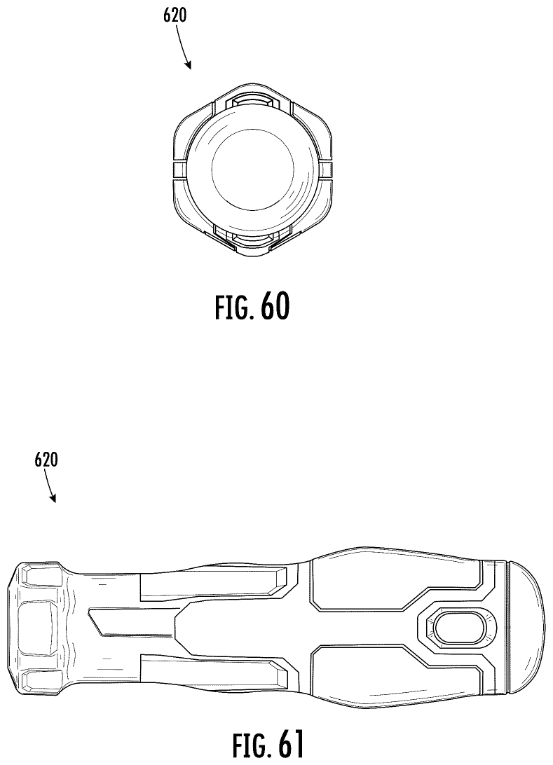

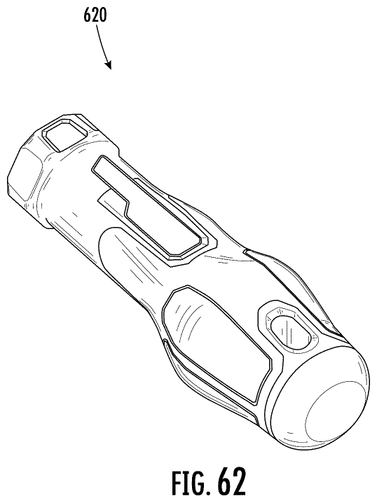

Referring to FIGS. 58-62, various aspects of handle 620 are shown. Handle 620 is functionally and structurally the same as handle 120, handle 220, handle 320, handle 370, handle 420, handle 470, handle 520 or handle 570 except for the differences described herein.

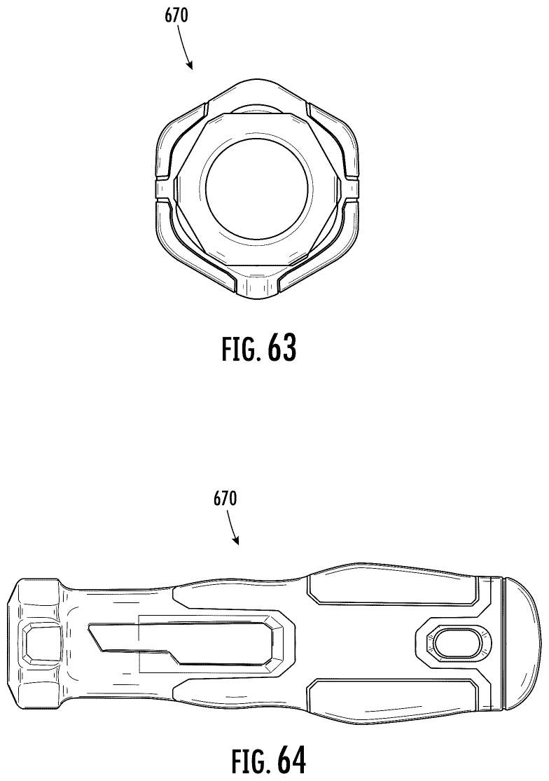

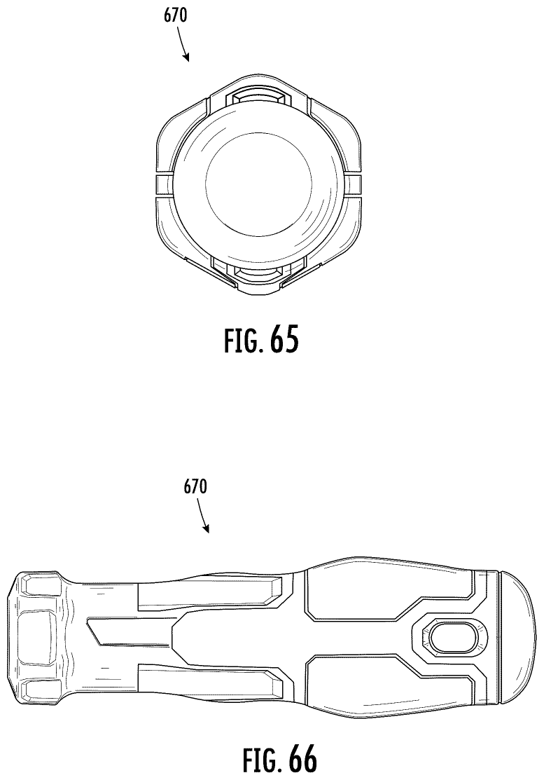

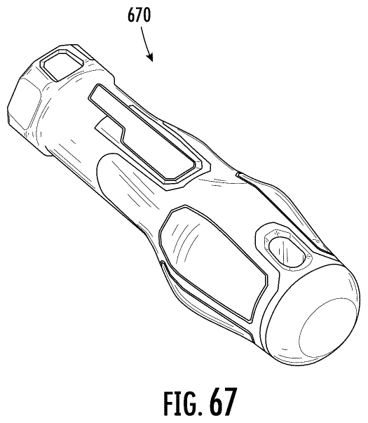

Referring to FIGS. 63-67, various aspects of handle 670 are shown. Handle 670 is functionally and structurally the same as handle 120, handle 220, handle 320, handle 370, handle 420, handle 470, handle 520, handle 570 or handle 620 except for the differences described herein.

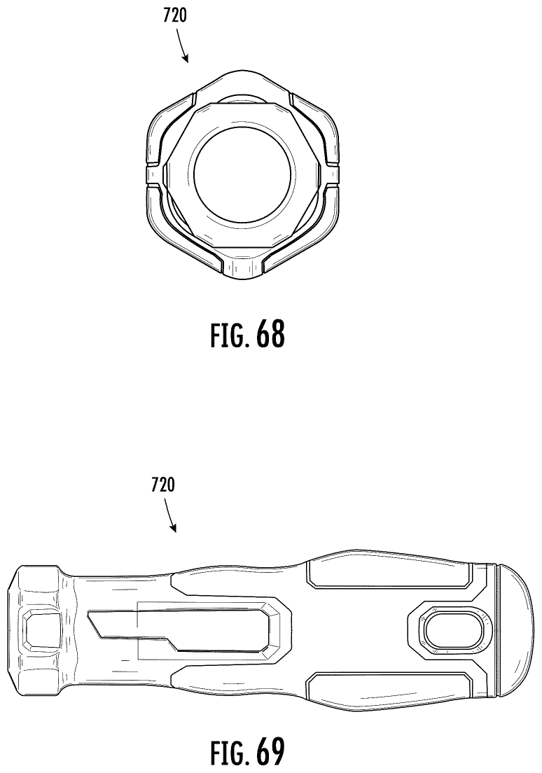

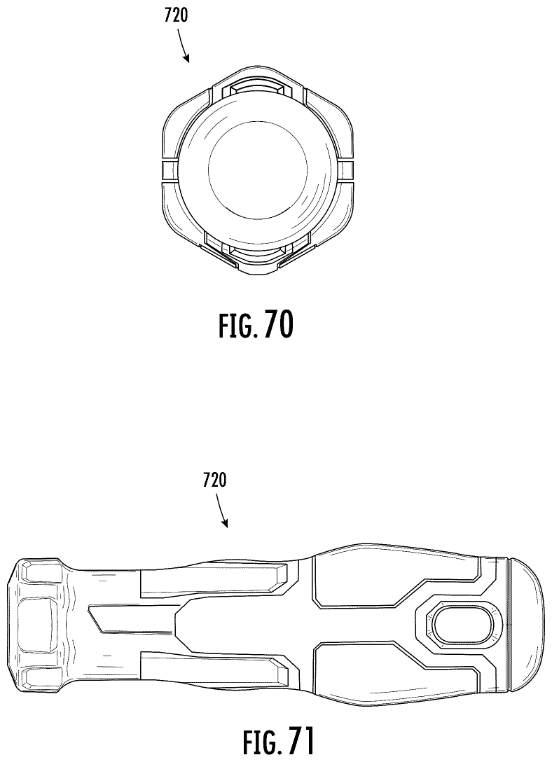

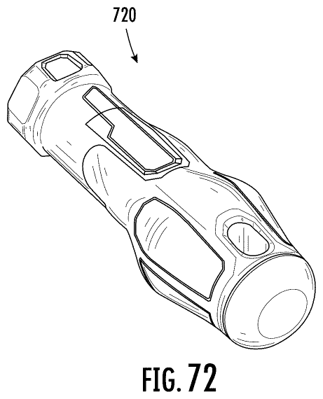

Referring to FIGS. 68-72, various aspects of handle 720 are shown. Handle 720 is functionally and structurally the same as handle 120, handle 220, handle 320, handle 370, handle 420, handle 470, handle 520, handle 570, handle 620 or handle 670 except for the differences described herein.

It should be understood that the figures illustrate the exemplary embodiments in detail, and it should be understood that the present application is not limited to the details or methodology set forth in the description or illustrated in the figures. It should also be understood that the terminology is for description purposes only and should not be regarded as limiting.

Further modifications and alternative embodiments of various aspects of the disclosure will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present disclosure.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more component or element, and is not intended to be construed as meaning only one. As used herein, “rigidly coupled” refers to two components being coupled in a manner such that the components move together in a fixed positional relationship when acted upon by a force.

Various embodiments of the disclosure relate to any combination of any of the features, and any such combination of features may be claimed in this or future applications. Any of the features, elements or components of any of the exemplary embodiments discussed above may be utilized alone or in combination with any of the features, elements or components of any of the other embodiments discussed above.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

In various exemplary embodiments, the relative dimensions, including angles, lengths and radii, as shown in the Figures are to scale. Actual measurements of the Figures will disclose relative dimensions, angles and proportions of the various exemplary embodiments. Various exemplary embodiments extend to various ranges around the absolute and relative dimensions, angles and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

What is claimed is:

1. A screwdriver comprising:
a handle extending along a longitudinal axis from a first end to a second end, the handle defining:
a first radius with respect to the longitudinal axis at a first distance from the first end to the second end;
a second radius with respect to the longitudinal axis at a second distance from the first end to the second end that is greater than the first distance, wherein the second radius is greater than the first radius;
a third radius with respect to the longitudinal axis at a third distance from the first end to the second end that is greater than the second distance, wherein the third radius is less than the first radius, wherein an exterior surface of the handle at the third distance from the first end to the second end is parallel to the longitudinal axis; and
a fourth radius with respect to the longitudinal axis at a fourth distance from the first end to the second end that is greater than the third distance, wherein the fourth radius is less than the third radius; and
an operative component rigidly coupled to the second end, the operative component is configured to interface with a fastener.

2. The screwdriver of claim 1, wherein a maximum radius of the handle is at the second distance from the first end to the second end.

3. The screwdriver of claim 1, wherein a minimum radius of the handle is at the fourth distance from the first end to the second end.

4. The screwdriver of claim 1, wherein the first distance is between 7% and 17% of the distance from the first end to the second end.

5. The screwdriver of claim 4, wherein the second distance is between 27% and 37% of the distance from the first end to the second end.

6. The screwdriver of claim 5, wherein the third distance is between 49% and 59% of the distance from the first end to the second end.

7. The screwdriver of claim 6, wherein the fourth distance is between 71% and 81% of the distance from the first end to the second end.
